(19) United States
(12) Patent Application Publication
(10) Pub. No.: US 2012/0103819 A1
(43) Pub. Date: May 3, 2012

(54) ALUMINUM ARTICLE AND PROCESS FOR MAKING SAME

(75) Inventors: HSIN-PEI CHANG, Tu-Cheng (TW); WEN-RONG CHEN, Tu-Cheng (TW); HUANN-WU CHIANG, Tu-Cheng (TW); CHENG-SHI CHEN, Tu-Cheng (TW); DAI-YU SUN, Shenzhen City (CN); HUA-YANG XU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/156,555

(22) Filed: Jun. 9, 2011

(30) Foreign Application Priority Data
Oct. 28, 2010 (CN) 201010523233.1

(51) Int. Cl. B32B 3/26; C25D 11/18

(52) U.S. Cl. 205/50; 205/201

(57) ABSTRACT

An aluminum article includes a substrate made of aluminum or aluminum alloy, a porous aluminum oxide layer formed on the substrate, and a transparent vacuum coated layer formed on the aluminum oxide layer. The aluminum oxide layer has a top surface and a plurality of pores defined therein. The pores run through the top surface and each pore is formed by peripheral wall and bottom wall. The vacuum coated layer covers the top surface as well as the peripheral walls and bottom walls of the pores, thereby forming a profile corresponding to the aluminum oxide layer.

### BACKGROUND

1. Technical Field

The disclosure generally relates to articles made of aluminum or aluminum alloy and processes for making the articles.

2. Description of Related Art

Due to having many good properties such as light weight and quick heat dissipation, aluminum and aluminum alloy are widely used in manufacturing components (such as housings) of electronic devices. Aluminum alloy housings are usually processed by anodizing or painting to achieve decorative coatings. However, the coatings formed by such processes have unchangeable color and are not very attractive.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary aluminum article and process for making the article. Moreover, in the drawings like reference numerals designate corresponding parts throughout the several views. Wherever possible, the same reference numbers are used throughout the drawings to refer to the same or like elements of an embodiment.

FIG. 1 is a schematic cross-sectional view of a substrate with a porous aluminum oxide layer of an exemplary aluminum article.

FIG. 2 is a schematic cross-sectional view of an exemplary aluminum article.

### DETAILED DESCRIPTION

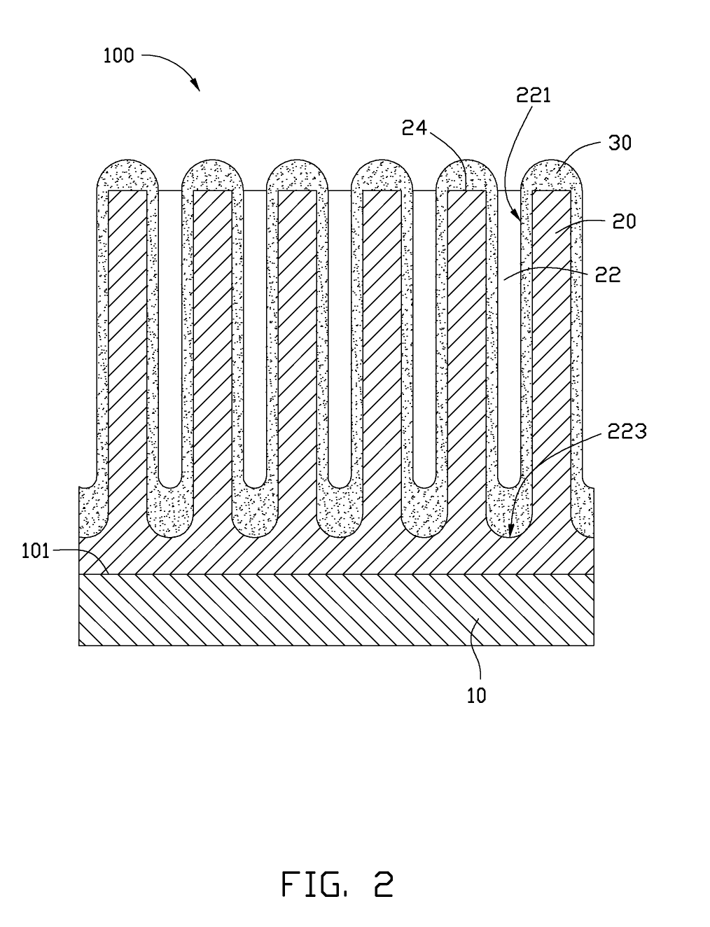

FIG. 2 shows an exemplary aluminum article 100. The aluminum article 100 includes a substrate 10, a porous aluminum oxide layer 20 formed on the substrate 10, and a transparent vacuum coated layer 30 formed on the aluminum oxide layer 20.

The substrate 10 may be made of aluminum or aluminum alloy.

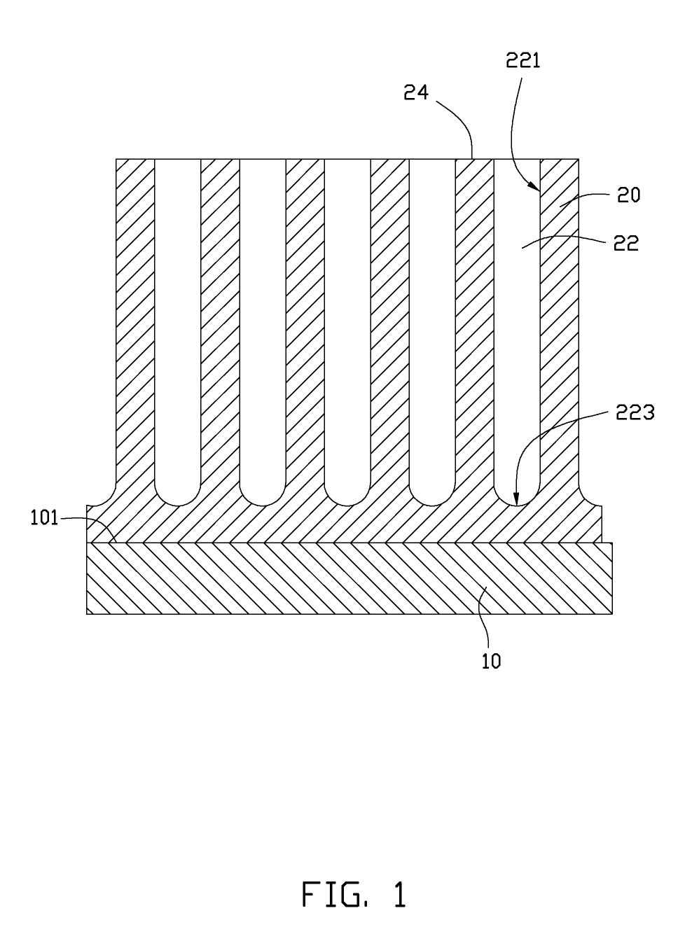

Referring to FIG. 1, the aluminum oxide layer 20 is directly formed on an outer surface 101 of the substrate 10. The aluminum oxide layer 20 has a top surface 24 and a plurality of fine pores 22 defined therein. The pores 22 run through the top surface 24. A peripheral wall 221 and a bottom wall 223 form each pore 22. The average aperture diameter of the pores 22 may be in a range from about 20 nm to about 200 nm, and preferably in a range from about 30 nm to about 60 nm. When the aperture of the pores 22 is smaller than 20 nm, the pores 22 may be easily filled up with the material of the vacuum coated layer 30. The thickness of the aluminum oxide layer 20 may be in a range from about 50 nm to about 500 nm. The aluminum oxide layer 20 may be formed by anodizing.

The vacuum coated layer 30 is formed on the aluminum oxide layer 20. The vacuum coated layer 30 covers the top surface 24 of the aluminum oxide layer 20 as well as the peripheral walls 221 and the bottom walls 223 of the pores 22, not filling up the pores 22, thereby forming a profile corresponding to the porous aluminum oxide layer 20. The vacuum coated layer 30 may be composed of metal, metal oxide, or nonmetal oxide. The metal may be selected from one of the group consisting of titanium, chromium, aluminum, zinc, and zirconium. The metal oxide may be selected from one of the group consisting of aluminum oxide, chromium oxide, zinc oxide, and zirconium oxide. The nonmetal oxide may be silicon dioxide. The vacuum coated layer 30 has a thickness between about 10 nm and about 150 nm. Portions of the vacuum coated layer 30 covering the side walls 221 of the pores 22 may be thinner than the portions of the vacuum coated layer 30 covering the top surface 24 and the bottom walls 223 of the pores 22, and this also can be seen in the figure. The thickness of the portions of the vacuum coated layer 30 covering the side walls 221 may be in a range from about 10 nm to about 60. The thickness of portions of the vacuum coated layer 30 covering the top surface 24 and the bottom walls 223 may be in a range from about 50 nm to about 150 nm, preferably in a range from about 50 nm to about 90 nm. When the thickness of the vacuum coated layer 30 is between about 10 nm and about 150 nm, the vacuum coated layer 30 is substantially transparent and colorless. When the thickness of the vacuum coated layer 30 is more than 150 nm, the vacuum coated layer 30 presents an obvious color of itself under naked eye observation.

Because the vacuum coated layer 30 is transparent and has a proper thickness, the vacuum coated layer 30 can present an interference color under light irradiation. Furthermore, the existence of the porous aluminum oxide layer 20 under the vacuum coated layer 30 makes the vacuum coated layer 30 have a porous surface. Thus, the aluminum article 100 can present different colors when viewed from different angles.

An exemplary process for making the aluminum article 100 may include the following steps.

A substrate 10 made of aluminum or aluminum alloy is provided.

The substrate 10 may be pretreated. The pretreatment includes degreasing and chemical polishing. The degreasing process may be carried out by cleaning the substrate 10 using acetone for about 5 minutes and then ultrasonically cleaning the substrate 10 with ethanol for about 30 minutes. The chemical polishing may be carried out by immersing the substrate 10 in a chemical solution comprising phosphoric acid, nitric acid and water with a ratio of about 3:1:1 by volume at a temperature of about 70° C. to about 80° C. for about 5 minutes.

Then the substrate 10 is anodized to create the porous aluminum oxide layer 20 on the outer surface 101 of the substrate 10. In one exemplary embodiment, the anodizing may be carried out in an electrolyte containing sulphuric acid at a concentration between about 0.2 mol/L and about 0.5 mol/L, using the substrate 11 as an anode. A voltage between about 15 volts (V) and about 50V is applied between the substrate 11 and the electrolyte for about 3 minutes (min) to about 10 min. The temperature of the electrolyte may be maintained at about 8° C. to about 12° C. during the anodizing.

In a second exemplary embodiment, the anodizing may be carried out in an electrolyte containing oxalic acid at a concentration between about 0.2 mol/L and about 0.5 mol/L, using the substrate 11 as an anode. A voltage between about 30V and about 60V is applied between the substrate 11 and the electrolyte for about 3 min to about 10 min. The temperature of the electrolyte may be maintained at about 1° C. to about 5° C. during the anodizing.

In a third exemplary embodiment, the anodizing may be carried out in an electrolyte containing phosphoric acid at a concentration between about 8 wt % and about 15 wt %, using the substrate 11 as an anode. A voltage between about 100V and about 200V is applied between the substrate 11 and the electrolyte for about 3 min to about 10 min. The temperature of the electrolyte may be maintained at about 2° C. to about 7° C. during the anodizing.

The porous aluminum oxide layer 20 is formed according to the anodizing process. The top surface 24 of the aluminum oxide layer 20 has a plurality of fine pores 22 defined therein.

Then, the substrate 11 with the aluminum oxide layer 20 may be processed by physical vapor deposition, such as sputtering, evaporation, or arc ion plating, to create the transparent vacuum coated layer 30. The thickness of the vacuum coated layer 30 may controlled in the range as described above by controlling the duration time of the physical vapor deposition, to ensure the vacuum coated layer 30 is transparent and colorless itself.

It is to be understood, however, that even through numerous characteristics and advantages of the exemplary disclosure have been set forth in the foregoing description, together with details of the system and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An aluminum article, comprising:
a substrate made of aluminum or aluminum alloy;
a porous aluminum oxide layer formed on the substrate, the aluminum oxide layer having a top surface and a plurality of pores defined therein, the pores running through the top surface and each pore formed by peripheral wall and bottom wall; and
a transparent vacuum coated layer formed on the aluminum oxide layer, the vacuum coated layer covering the top surface as well as the peripheral walls and bottom walls of the pores, thereby forming a profile corresponding to the aluminum oxide layer.

2. The aluminum article as claimed in claim 1, wherein the average aperture diameter of the pores is in a range from about 20 nm to about 200 nm.

3. The aluminum article as claimed in claim 2, wherein the average aperture diameter of the pores is in a range from about 30 nm to about 60 nm.

4. The aluminum article as claimed in claim 2, wherein the vacuum coated layer has a thickness between about 10 nm and about 150 nm.

5. The aluminum article as claimed in claim 4, wherein portions of the vacuum coated layer covering the side walls is thinner than the portions of the vacuum coated layer covering the top surface and the bottoms.

6. The aluminum article as claimed in claim 5, wherein the thickness of the portions of the vacuum coated layer covering the peripheral walls is in a range from about 10 nm to about 60 nm.

7. The aluminum article as claimed in claim 5, wherein thickness of portions of the vacuum coated layer covering the top surface and the bottom walls is in a range from about 50 nm to about 150 nm.

8. The aluminum article as claimed in claim 7, wherein thickness of portions of the vacuum coated layer covering the top surface and the bottom walls is in a range from about 50 nm to about 90 nm

9. The aluminum article as claimed in claim 1, wherein the vacuum coated layer is composed of one of the group consisting of titanium, chromium, aluminum, zinc, and zirconium.

10. The aluminum article as claimed in claim 1, wherein the vacuum coated layer is composed of one of the group consisting of aluminum oxide, chromium oxide, zinc oxide, zirconium oxide, and silicon dioxide.

11. The aluminum article as claimed in claim 1, wherein the aluminum oxide layer is formed by anodizing.

12. The aluminum article as claimed in claim 1, wherein the vacuum coated layer is formed by one of the methods of sputtering, evaporation, and arc ion plating.

13. A method for making an aluminum article comprising steps of:
providing a substrate made of aluminum or aluminum alloy;
anodizing the substrate to form a porous aluminum oxide layer on the substrate, the aluminum oxide layer having a top surface and a plurality of pores defined therein, the pores running through the top surface and each pore formed by peripheral wall and bottom wall; and
forming a transparent and colorless vacuum coated layer on the aluminum oxide layer by physical vapor deposition, the vacuum coated layer covering the top surface as well as the peripheral walls and bottom walls of the pores, thereby forming a profile corresponding to the aluminum oxide layer.

14. The method as claimed in claim 13, wherein the anodizing is carried out in an electrolyte containing about 0.2 mol/L-0.5 mol/L sulphuric acid at a temperature of about 8° C.-12° C., using the substrate as an anode, and applying a voltage between about 15V and about 50V between the substrate and the electrolyte for about 3 min-10 min.

15. The method as claimed in claim 13, wherein the anodizing is carried out in an electrolyte containing about 0.2 mol/L-0.5 mol/L oxalic acid at a temperature of 1° C.-5° C., using the substrate as an anode, and applying a voltage between about 30V and about 60V between the substrate and the electrolyte for about 3 min-10 min

16. The method as claimed in claim 13, wherein the anodizing is carried out in an electrolyte containing about 8 wt %-15 wt % phosphoric acid at a temperature of about 2° C.-7° C., using the substrate as an anode, and applying a voltage between about 100V and about 200V between the substrate and the electrolyte for about 3 min-10 min.

17. The method as claimed in claim 13, wherein the average aperture of the pores is in a range from about 20 nm to about 200 nm.

18. The method as claimed in claim 13, wherein the vacuum coated layer has a thickness between about 10 nm and about 150 nm.

19. The method as claimed in claim 13, wherein vacuum coated layer is composed one of the group consisting of titanium, chromium, aluminum, zinc, zirconium, aluminum oxide, chromium oxide, zinc oxide, zirconium oxide, and silicon dioxide.

20. The method as claimed in claim 13, wherein vacuum coated layer is formed by one of the methods of sputtering, evaporation, and arc ion plating.
